(19) United States
(12) Patent Application Publication
(10) Pub. No.: US 2024/0419677 A1
(43) Pub. Date: Dec. 19, 2024

(54) METHODS AND APPARATUS FOR DONATING IN-APP SEARCH QUERIES, EVENTS, AND/OR ACTIONS

(71) Applicant: GOOGLE LLC, Mountain View, CA (US)

(72) Inventors: Keun Soo Yim, San Jose, CA (US); Adam Coimbra, Cupertino, CA (US)

(21) Appl. No.: 18/335,705

(22) Filed: Jun. 15, 2023

(51) Int. Cl. G06F 16/248; G06F 16/2453; G06F 16/2455

(52) U.S. Cl. CPC G06F 16/248; G06F 16/24542; G06F 16/2455

(57) ABSTRACT

Implementations include receiving search-based content donated by a first application installed at a client device, and processing the search-based content to generate a first entry in a central on-device repository that locally stores content donated by different applications installed at the client device. Implementations further include receiving, via a unified interface that is independent of the first and second applications, a search query from the user and, in response to receiving the search query via the unified interface, searching the central on-device repository to determine whether any entry in the central on-device repository is responsive to the search query. If it is determined that the first entry is responsive to the search query, an interface element is generated based on the first entry, and the generated interface element is rendered at the unified interface, for potential selection by the user.

### BACKGROUND

Users, when using a client device such as a smart phone, are often presented with a plurality of applications installed at, or otherwise accessible, via the client device. From the plurality of presented applications, users can choose to access a desired application to perform a desired action. For example, a user can access a music app and play (or search for) a song performed by a particular singer the user likes. As another example, the user can select a browser to view media content (e.g., blogs).

Given the amount of applications accessible via the client device or as time goes by, there are chances that the user cannot remember exactly which app and/or search terms she or he uses to access certain content (e.g., a particular movie, or a particular page of an electronic book), or to perform certain action (turn on a smart light, of various smart lights, that is configured to have a particular brightness and color). As a result, in order to access such content or perform such action again, the user will need to open different apps one after another and/or try different search terms, to find the certain content (or action) the user is interested in accessing (or performing) again. This can prolong interaction of the user with the client device and cause excess utilization of battery, processor, and/or other resources of the client device.

### SUMMARY

Implementations disclosed herein relate to receiving, by a client device and from a plurality of applications installed at the client device, search-based content (e.g., user inputted search query/terms, automatic generated search suggestions, and/or in-app content accessed within an application based on user input, etc.) accessed by a user of the client device using one or more of the plurality of applications, and/or activity-based content describing user activity or action performed by the user via one or more of the plurality of applications. The received search-based content and/or activity-based content can be stored in a local memory of the client device, to build or update a central on-device repository locally stored at the client device.

A unified user interface (sometimes referred to as “unified interface”) corresponding to the central on-device repository can be generated. In response to an icon representing the unified interface being selected by a user (or in response to receiving a spoken utterance of the user requesting access to the unified interface), the unified user interface can be invoked for display at the client device. The unified interface can be a graphical user interface (GUI) that includes a search field to receive user input. Based on the received user input, a cross-app search query can be generated and be used to perform a cross-app search, using the central on-device repository. As a result, one or more entries responsive to the cross-app search query can be determined from the central on-device repository, to generate one or more search results.

The one or more search results can be displayed to the user (e.g., to receive user selection) and can each correspond to a respective entry, of the aforementioned one or more entries, from the central on-device repository. For instance, based on the one or more search results, one or more interface elements can be generated. In some cases, each of the one or more interface elements can correspond to a respective search result, of the one or more search results, that describes a respective entry from the one or more entries in the central on-device repository. In some other cases, the one or more search results can be ranked and a subset (e.g., top ranked) of the search results can be used to generate the one or more interface elements. The one or more interface elements can be rendered at the unified interface responsive to the received user input. The one or more interface elements can be selectable to facilitate user selection (click, touch, etc.).

In some implementations, the aforementioned in-app content (e.g., a document, a webpage, etc.) can include on-device content (i.e., content locally stored at the client device via the plurality of applications), and/or off-device content (i.e., content not locally stored at the client device but accessible via, e.g., a network, using the plurality of applications). In these implementations, the unified interface can be a search interface that enables cross-app searching of the on-device content and the off-device content.

By searching through the unified interface, the user interested in re-visiting certain content or performing a previously performed action (or continuing to perform a previously paused action) does not need to open applications individually to identify how the certain content or a desired action is accessible (e.g., which app is applicable to access the certain content, to continue performing the paused action, or to perform the previously performed action). Nor does the user need to remember a path or shortcut that leads to the certain content or the desired action, since a search conducted through the unified interface could return search result(s) that, when selected, causes the certain content to be displayed or the desired action to be performed/continued. In this way, not only the user experience can be enhanced, but also excess utilization of battery, processor, and/or other resources of the client device can be avoided or reduced.

As a working example, the client device can be installed with a music app, among several other applications, where a user of the client device can use the music app for listening to songs or browsing music news, etc. For instance, to play a song named “wheels on the bus”, the user can provide user input (may be referred to as “user query”), via the music app, that includes one or more characters, such as a prefix of “wheels o” or “wheels on the bus” in its entirety. The user input can be typed in by the user at a search field of the music app, or can be identified/translated from a spoken utterance (e.g., “search ‘wheels on the bus’”) received from the user via one or more microphones of the client device.

In some cases, the music app may suggest an in-app search query such as “wheels on the bus” in response to receiving incomplete user input (e.g., “wheels o”), before the user types in “wheels on the bus” in its entirety. In these cases, the user can select the suggested in-app search query of “wheels on the bus”, and in response, one or more in-app search results associated with the song “wheels on the bus” can be displayed to the user, for user selection and/or access. For instance, in response to the user selecting the suggested in-app search query of “wheels on the bus”, the music app can determine that there are 10 search results being responsive to a search (i.e., in-app search) for “wheels on the bus” within the music app, and display the 10 search results for selection or access by the user. The 10 search results, for instance, can include 10 different versions of “wheels on the bus” that are accessible via the music app, some being videos, some being audios, some being a live version performed during a concert, or each being performed by a different artist.

The user may select, from the 10 search results, a particular search result indicating that a version of “wheels on the bus” performed by artist C is available for access via the music app. In response to such user selection, the version of “wheels on the bus” performed by artist C can be played to the user via the music app. Based on the user query of “wheels o”, user selection of the particular search result, and/or the play of “wheels on the bus” by artist C, the music app can generate search-based content and donate the generated search-based content to the central on-device repository. The search-based content, for example, can include the user query of “wheels o”.

Alternatively or additionally, the search-based content can include the suggested in-app search query of “wheels on the bus”. Alternatively or additionally, the search-based content can include the song “wheels on the bus” performed by artist C or an entity identifier for the song “wheels on the bus” performed by artist C. Alternatively or additionally, the search-based content can include an identifier for the music app. Alternatively or additionally, the search-based content can include a link or shortcut that, when executed, causes the display of the song “wheels on the bus” (by artist C) in the music app.

It's noted that the search-based content is not limited to descriptions above. For instance, the search-based content can, alternatively or additionally, include a timestamp (e.g., 1:50 min out of 2:59 min) indicating where the user stopped listening to the song “wheels on the bus” by artist C, or a percentage (e.g., 78%) of the song consumed by the user using the music app. The search-based content can, alternatively or additionally, include a timestamp recording a time point (e.g., Dec. 20, 2021, at 8:00 pm) at which the user listens to or watches the song “wheels on the bus” (by artist C) using the music app.

Continuing with the above working example, in response to receiving the search-based content donated by the music app to the central on-device repository, an entry can be created in the central on-device repository for the received search-based content. The received search-based content can be processed/parsed and the entry created in the central on-device repository for the received search-based content can include any applicable portion of the received search-based content. For instance, the entry can include a plurality of entry portions, such as a source application portion that records the music app as a source application, donated content portion that records the song “wheels on the bus” by artist C or an entity identifier for the song “wheels on the bus” by artist C, a fulfillment portion that records a link or shortcut that when executed, causes the song “wheels on the bus” (by artist C) to be displayed via the music app, a content-accessing timestamp portion that records the latest moment the user accesses the song “wheels on the bus” (by artist C) using the music app, and/or a progress portion that records a percentage of content (here the song “wheels on the bus” by artist C) consumed by the user during last visit.

Subsequently, when the user types an in incomplete user input such as “wheels o” (or a complete user input of “wheels on the bus”) at a search field of the unified interface, a cross-app search query of “wheels o” (or “wheels on the bus”) can be generated and used to search the central on-device repository.

Alternatively, when the user types in incomplete user input of “wheels o” at the search field of the unified interface, one or more automatic cross-app search query suggestions (e.g., a first cross-app automatic search query suggestion of “wheels on the bus” and a second cross-app automatic search query suggestion of “wheels on”) can be generated and displayed to the user via the unified interface for user selection. In this case, if the user selects the first automatic cross-app search query suggestion of “wheels on the bus”, the first cross-app automatic search query suggestion of “wheels on the bus” can be used to search the central on-device repository.

Searching the central on-device repository using the aforementioned cross-app search query of “wheels o” or using the first cross-app automatic search query suggestion of “wheels on the bus” selected by the user, can yield a determination of whether any responsive entry in the central on-device repository. For instance, in response to such searching, an entry in the central on-device repository that corresponds to the song “wheels on the bus” (by artist C) accessible via the music app, as well as an additional entry in the central on-device repository that corresponds to a blog introducing a concert performing “wheels on the bus” that is accessible via a social media app, can be identified to be responsive to the cross-app search query of “wheels o” (or the first cross-app automatic search query suggestion of “wheels on the bus” selected by the user). In this case, a first interface element can be generated based on the entry that corresponds to the song “wheels on the bus” (by artist C) accessible via the music app, and a second interface element can be generated based on the additional entry that corresponds to the blog introducing the concert performing “wheels on the bus” accessible via the social media app.

The first and second interface elements can be displayed to the user at the unified interface, for selection by the user (e.g., via a link embedded in each of the first and second interface elements). If the user selects the first interface element, the music app can be triggered in a particular state. For instance, in response to the user selecting the first interface element, a user interface of the music app can be triggered for display, and the song “wheels on the bus” (by artist C) can be displayed at the user interface of the music app. In this way, the user does not need to recall which app was previously used to play “wheels on the bus” by artist C. Nor does the user need to further recall which path leads to the play of “wheels on the bus” by artist C. The user can access the “wheels on the bus” by artist C through a search via the unified interface, without accessing applications one after another when the user does not remember how the “wheels on the bus” by artist C is previously retrieved/accessed.

In some implementations, for a respective application of the plurality of applications, search-based content responsive to a search performed by the user within the respective application can be, or include, a user query in natural language, that is used to perform the search. For example, as mentioned previously, the search-based content can be “wheels on the bus” in natural language, received as a user query from the user at a search field of a music app. Alternatively or additionally, the search-based content can be, or can include, an entity identifier (sometimes referred to as “content identifier”) of an entity (e.g., an identifier of the song “wheels on the bus”) from the user query. The entity identifier does not necessarily reveal the entity being the song “wheels on the bus”, but when used by the music app or when used in association with the music app, can identify the entity being, for instance, the song “wheels on the bus”. Alternatively, as mentioned previously, the search-based content can be “wheels on the bus” in natural language, translated or determined from a spoken utterance of the user, such as “search for ‘wheels on the bus’” or “search the music app for wheels on the bus”.

In some implementations, the user query can be a partial query (i.e., an incomplete query). For example, as mentioned previously, the user query can be “wheels o”, based on which an automatic suggestion of “wheels on the bus” can be determined by the music app and be displayed to the user for selection via the music app. In this example, the search-based content responsive to a search performed by the user within the respective application can be “wheels o”. Optionally, the search-based content can further include an entity identifier of an entity (e.g., an identifier of the song “wheels on the bus”) determined from the partial query.

In some implementations, the search-based content responsive to a search performed by the user within the respective application can be, or can include, a link that when executed, causes the respective application to be launched in a particular state. For example, the link can include a name or identifier of the respective application (e.g., the music app), and a name or identifier of an entity (e.g., “wheels on the bus”) from the search performed by the user within the respective application. In this example, when the link including the identifier of the music app and the identifier of the song “wheels on the bus” is selected/executed via the unified interface which is separate from the music app, the music app can be launched in a particular state. The particular state of the music app, for instance, can be a state of the music app where a graphical user interface of the music app displays a video or audio of the song “wheels on the bus” by artist C and/or operations for the song, such as “play”, “pause”, “stop”, etc.). Alternatively, the particular state of the music app can be a state where a video or audio of the song “wheels on the bus” starts playing (e.g., automatically) once the music app is launched.

As another example, the link can include a name or identifier of the respective application (e.g., the music app), and the user query (e.g., “wheels on the bus”) used by the user to perform the search within the respective application. In this example, when such link is executed, the music app can be launched in a particular state where a graphical user interface of the music app is, or includes, a search result interface that displays one or more search results for the search performed by the user within the respective application. For instance, in response to the link including the identifier of the music app and the identifier of the song “wheels on the bus” is executed via the unified interface, the music app can be launched in a state where a search result interface showing 10 search results (10 different versions of the song “wheels on the bus”) that are responsive to the user query of “wheels on the bus” (or “wheels o”).

Alternatively or additionally, in some implementations, the search-based content responsive to a search performed by the user within the respective application can include an indication of whether the search performed by the user is personalized or public. In some implementations, the respective application (e.g., the music application) can determine whether the search is personalized or public, e.g., based on a frequency that the user query (e.g., “wheels on the bus” or “wheels o”, and/or the automatic search suggestion generated based on the user query) is received by the respective application. For instance, if such frequency exceeds a frequency threshold, the search can be determined by the respective application as being “public”, and if the frequency does not exceed the frequency threshold, the search can be determined by the respective application as being “personalized”.

Optionally, in some implementations, entries in the central on-device repository determined as being responsive to a search received via the unified interface can be ranked. For instance, the user can enter keywords such as “wheels on” at a search field of the unified interface, and the central on-device repository can be searched so that three entries of the central on-device repository are determined as being responsive to the keywords “wheels on” via the unified interface. The three entries, for instance, can include first search-based content (e.g., user query of “wheels on the bus”) donated by a first application (e.g., the music app), second search-based content (user query for a game named “wheels on”) donated by a second application (e.g., a gaming app), and a second search-based content (e.g., user query for “wheels on the bus toy”) donated by a third application (e.g., a department store app).

In the above instance, if the first search-based content includes an indication indicating that the user query of “wheels on the bus” performed via the first application is personalized, while the second and third search-based content include no such indication or respectively includes an indication indicating that the user query of “wheels on” or “wheels on the bus toy” is public, the first search-based content can be ranked higher than the second search-based content) and the third search result. In this case, a search result corresponding to the first search-based content can be displayed to the user via the unified interface, instead of displaying three search results each corresponding to one of the first, second, and third search-based content.

In some implementations, a search result that corresponds to the highest ranked search-based content (e.g., the aforementioned first search-based content) can be displayed at the unified interface as a selectable element. The search result can, for instance, include the user query “wheels on the bus” performed via the music app and/or an identifier (e.g., icon or text) of the music app. Optionally, the selectable element can be embedded with, or be associated with, fulfillment data (e.g., “play the song ‘wheels on the bus’ by artist C when the music app is launched”). In this case, when the selectable element is executed, the fulfillment data can be used to launch the music app in the particular state (e.g., where the song “wheels on the bus” by artist C is automatically played via the music app once the music app is launched).

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain implementations of the present disclosure will be more apparent from the following description taken in conjunction with the accompanying drawings. In the drawings:

FIG. 1A depicts a block diagram of an example environment that demonstrates various aspects of the present disclosure, and in which implementations disclosed herein may be implemented.

FIG. 1B depicts a flow chart showing cross-app search results generated based on partial user input, in accordance with various implementations.

FIG. 1C depicts an example central on-device repository, in accordance with various implementations.

FIG. 2A depicts an example unified interface having a search field, in accordance with various implementations.

FIG. 2B depicts the user interface in FIG. 2A receiving partial user input, in accordance with various implementations.

FIG. 2C depicts the user interface displaying one or more cross-app search results determined based on the partial user input in FIG. 2B, in accordance with various implementations.

FIG. 2D depicts an example user interface of a music application being displayed in response to user selection of a corresponding cross-app search result, of the one or more cross-app search results in FIG. 2C, in accordance with various implementations.

FIG. 2E depicts another example user interface of a book application being displayed in response to user selection of a corresponding cross-app search result, of the one or more cross-app search results in FIG. 2C, in accordance with various implementations.

FIG. 3 illustrates an example method for cross-app searching, in accordance with various implementations.

FIG. 4 illustrates another example method for cross-app searching, in accordance with various implementations.

FIG. 5 illustrates a further example method for cross-app searching, in accordance with various implementations.

FIG. 6 illustrates an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various implementations of the present disclosure is provided for the purpose of illustration only and not for the purpose of limiting the present disclosure as defined by the appended claims and their equivalents.

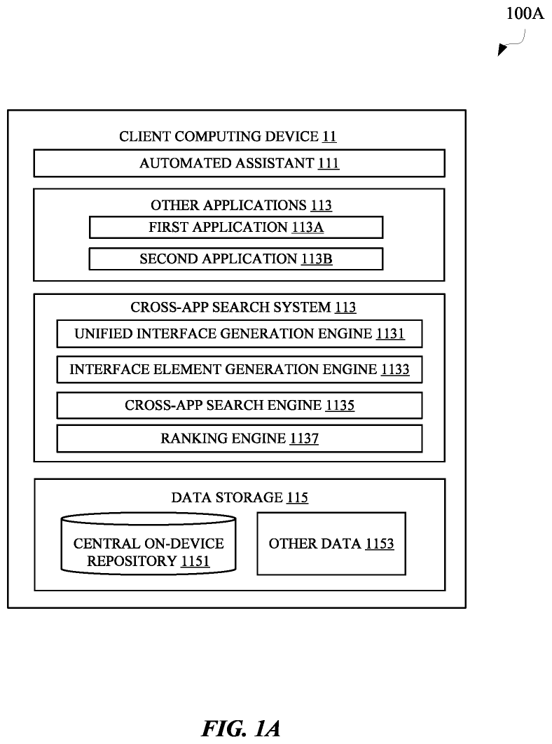

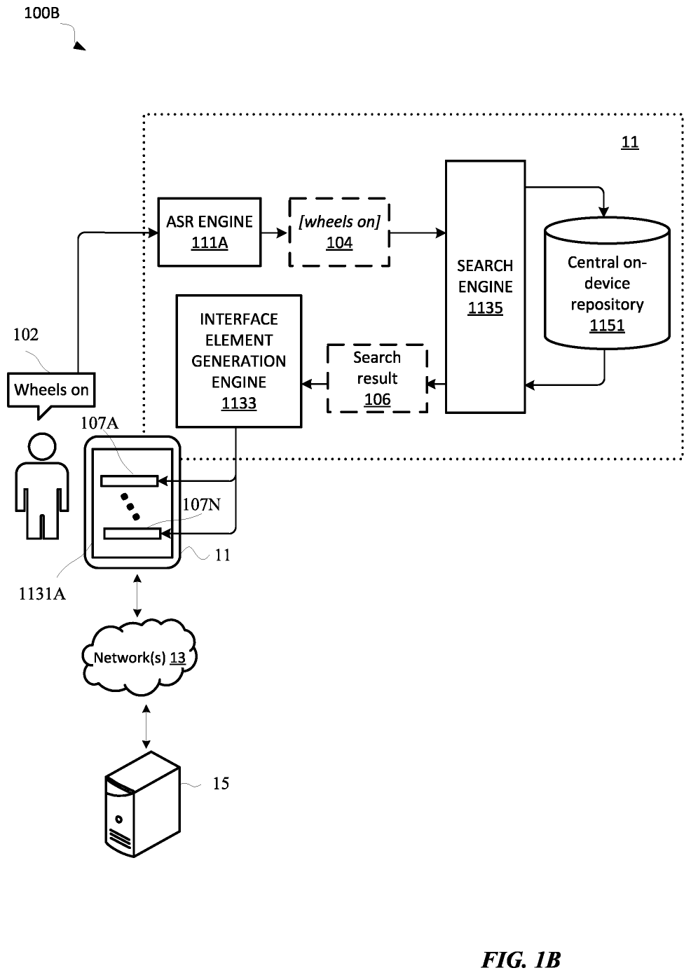

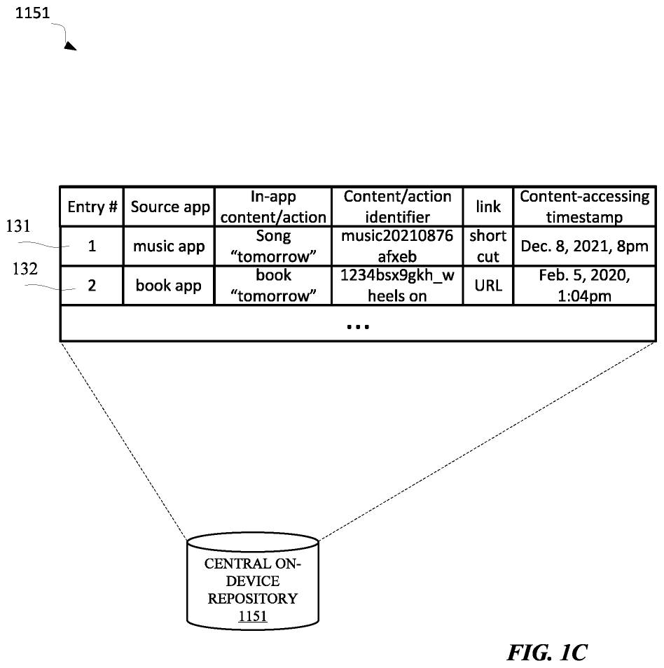

FIG. 1A is a block diagram of an example environment 100A that demonstrates various aspects of the present disclosure, and in which implementations disclosed herein may be implemented. As shown in FIG. 1A, in various implementations, the environment 100A can include a client computing device 11 (may be referred to simply as “client device”) that includes an automated assistant application 111 (may be referred to simply as “automated assistant”), and one or more other applications 113. The one or more other applications 113 can be installed at the client device 11. As a non-limiting example, the one or more other applications 113 can include a first application 113A (e.g., a music app, a social media app, a messaging app, or any other applicable app) installed at the client device 11, and a second application 113B (e.g., a book reader or any other applicable app) installed at the client device 11. The client device 11 can be, for example, a cell phone, a laptop, a desktop, a notebook computer, a tablet, a smart TV, a messaging device, or a personal digital assistant (PDA), and the present disclosure is not limited thereto.

In various implementations, the client device 11 can further include a cross-app search system 113 and a data storage 115. In various implementations, the cross-app search system 113 can include a unified interface generation engine 1131, an interface element generation engine 1133, and/or a cross-app search engine 1135 (may be referred to simply as “search engine”). Optionally, in some implementations, the cross-app search system 113 can further include a ranking engine 1137. In various implementations, the data storage 115 can include a central on-device repository 1151 and other data 1153 (e.g., metadata associated with the first application 113A or the second application 113B, user profile associated with the client device 11, etc.)

In various implementations, the central on-device repository 1151 can include a plurality of entries created based on content or information donated by the first application 113A, the second application 113B, and/or other additional application(s), that are installed at the client device 11. The content or information donated by the first application 113A can be search-based content such as incomplete or complete search query (or user input) received by the first application 113A from a user, a search result that is selected by the user and that identifies an entity (e.g., a song) responsive to the incomplete or complete search query, and/or an entity identifier corresponding to the identified entity. The entity identifier does not necessarily need to reveal the identified entity/content (e.g., “wheels on the bus” performed by singer A) on its face, but can be used by the first application 113A to identify or locate the identified entity. For instance, the entity identifier can be a combination of numbers and letters that maps to the identified entity.

Alternatively or additionally, the search-based content can be, or can include, a link (e.g., URL or other fulfillment) that, when executed, causes the entity identified in the user-selected search result, to be displayed to the user via a user interface of the first application 113A. Alternatively, the link, when executed, can cause the one or more search results that are displayed by the first application 113A to the user for selection, to be displayed via a user interface of the first application 113A.

Alternatively or additionally, the search-based content can include an indication indicating whether the incomplete or complete search query is personalized or public. Whether the incomplete or complete search query is personalized or public can be determined, for instance, based on a frequency that the user query (e.g., “wheels on the bus” or “wheels o”, and/or the automatic search suggestion generated based on the user query) is received by the respective application. In this instance, if such frequency exceeds a frequency threshold, the search can be determined by the respective application as being “public”, and if the frequency does not exceed the frequency threshold, the search can be determined by the respective application as being “personalized”.

Alternatively or additionally, the content or information donated by the first application 113A can be activity-based content such as user action/activity completely or substantially performed using the first application 113A, or other applicable types of content or information.

As a non-limiting example, the first application 113A can be a music app, and a user (e.g., authorized or registered user) of the client device 11 previously used the music app to play a song “tomorrow” (by singer A) that was recommended to the user for listening. The music app can, based on user activity of using the music app to play the song “tomorrow” for a time period (e.g., listened to the song in its entirety) that exceeds a predetermined amount of time, donate activity-based content describing such user activity to the central on-device repository 1151. FIG. 1C depicts a non-limiting example of a central on-device repository, in accordance with various implementations. For instance, referring to FIG. 1C, in response to receiving the donated activity-based content from the music app, a first entry 131 can be created in the central on-device repository 1151, where the first entry can record a name of a source application (i.e., the application that donates the content, which in this case is the music app), a user activity (e.g., play the song “tomorrow” by singer A) or in-app content (or action) accessed by the user (e.g., song “tomorrow”) during the user activity, an identifier (e.g., music20210876afxeb) of the in-app content recognized by the music app itself, a type of the in-app content (e.g., music, book, social media post, etc.), whether the in-app content is accessible by the source app locally or remotely (e.g., on-device vs. off-device), a time at which the user activity was detected (e.g., Dec. 8, 2021, at 8 pm), a time at which the content was donated to the central on-device repository 1151 (e.g., Dec. 1, 2021, at 8:05 pm), and/or other information (e.g., a link or shortcut that, when executed, causes rendering of an interface of the music app that displays the song “tomorrow” for play).

As another non-limiting example, the user previously searched the music app to listen to the song “wheels on the bus” by typing in “wheels o” at a search field of the music app. In this example, the incomplete user input of “wheels o” can be donated by the user as search-based content to the central on-device repository 1151, in response to the search field of the music app receiving the incomplete user input of “wheels o”. Alternatively, the music app may not donate the incomplete user input of “wheels o” to the central on-device repository 1151 in response to the search field of the music app receiving the incomplete user input of “wheels o”. Instead, in responsive to the search field of the music app receiving the incomplete user input of “wheels o”, the music app may generate and display one or more search results (e.g., including a search result of “wheels on the bus” performed by singer A) responsive to the incomplete user input of “wheels o” to the user of the music app. The user can select the search result of “wheels on the bus” by singer A, from the one or more displayed search results, and in response to the user selecting such search result, the music app can donate the incomplete user input of “wheels o” to the central on-device repository 1151.

Alternatively, the music app may not donate the incomplete user input of “wheels o” to the central on-device repository 1151 in response to the user selecting the search result of “wheels on the bus” by singer A, from the one or more displayed search results. Instead, the music app can donate the incomplete user input of “wheels o” to the central on-device repository 1151 in response to the user listening to, using the music app, the song “wheels on the bus” performed by singer A, for a substantially amount of time (e.g., half of the length of the song) that exceeds a predetermined threshold (e.g., percentage threshold or time period threshold).

Alternatively or additionally, the music app can donate the search result of “wheels on the bus” by singer A, as search-based content, to the central on-device repository 1151. Such donation can be performed in response to the user selecting the search result of “wheels on the bus” by singer A, from the one or more displayed search results, or in response to the user listening to, using the music app, the song “wheels on the bus” performed by singer A, for a substantially amount of time.

In some implementations, instead of the incomplete user input of “wheels o”, the music app can receive a complete user input of “wheels on the bus” and determine one or more search results responsive to the complete user input of “wheels on the bus”. For instance, the one or more search results can include a first search result embedded with a link to an audio version of “wheels on the bus” by singer A and a second search result embedded with a link to a video version of the “wheels on the bus” by singer B. The user may select the first search result and watched the video version of the “wheels on the bus” by singer B in its entirety. In this case, the music app can donate the complete user input of “wheels on the bus”, as search-based content, to the central on-device repository 1151. Such donation can be performed in response to the user selecting the search result of “wheels on the bus” by singer A, from the one or more displayed search results, or can be performed in response to the user listening to, using the music app, the song “wheels on the bus” performed by singer A, for a substantially amount of time.

In some implementations, the music app can donate the incomplete user input of “wheels o” (or the complete user input of “wheels on the bus”) as search-based content to the central on-device repository 1151, as well as the user activity of watching the song “wheels on the bus” performed by singer A as activity-based content to the central on-device repository 1151. Such donation can be performed in response to the user watching or listening to, using the music app, the song “wheels on the bus” performed by singer A, for a substantial amount of time that exceeds the predetermined threshold.

Referring to FIG. 1C, a second entry 132 can be created in the central on-device repository 1151, based on the incomplete user input of “wheels o”. The second entry 132, for instance, can include a name or identifier of a source application (which in this case is the music app) that donates the incomplete user input of “wheels o”, donated content (i.e., wheels o), a search result of “wheels on the bus” (performed by singer A) selected by the user, and/or a time point at which the user stopped watching “wheels on the bus” (performed by singer A). It's noted that the first and second entries in FIG. 1C are shown for illustration, and are not intended to be limiting.

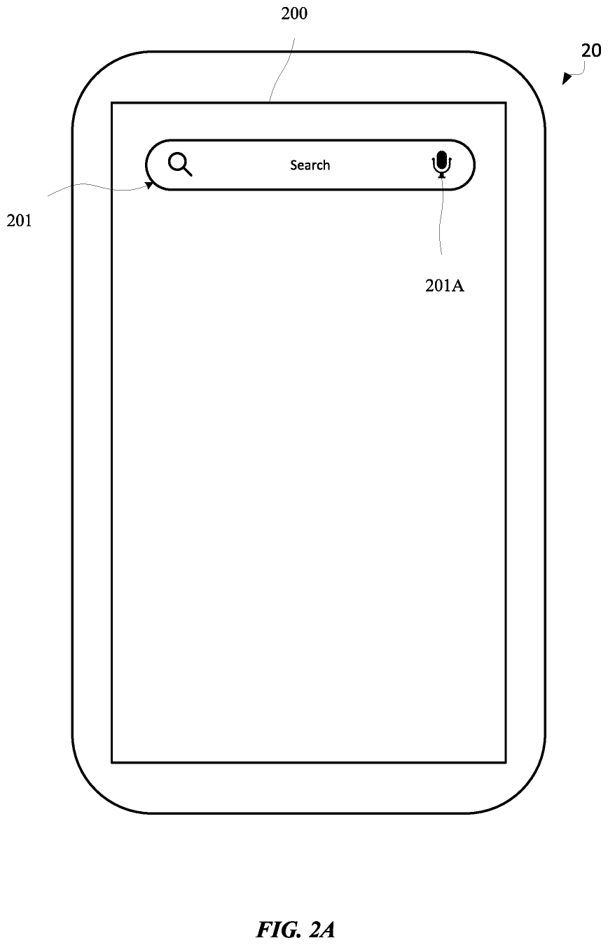

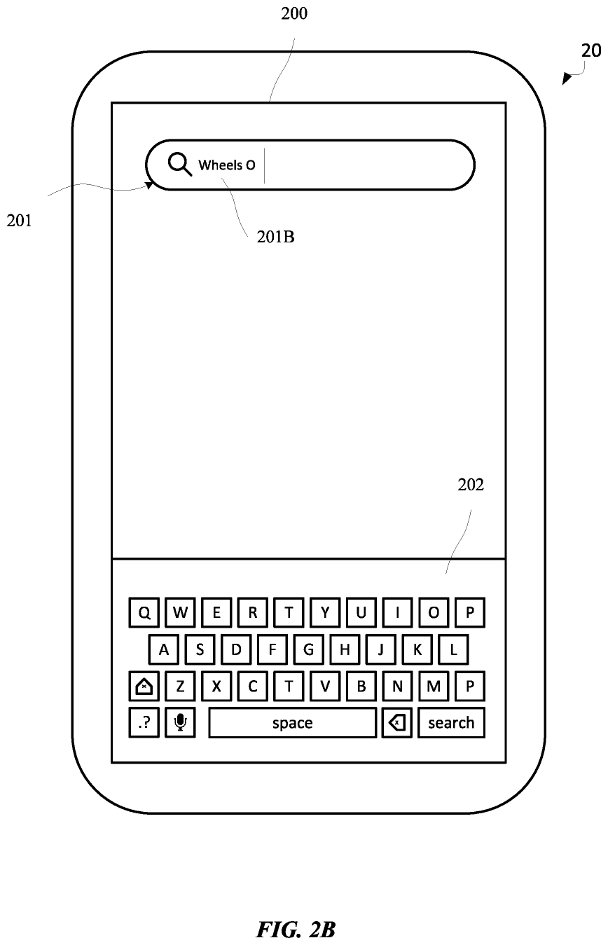

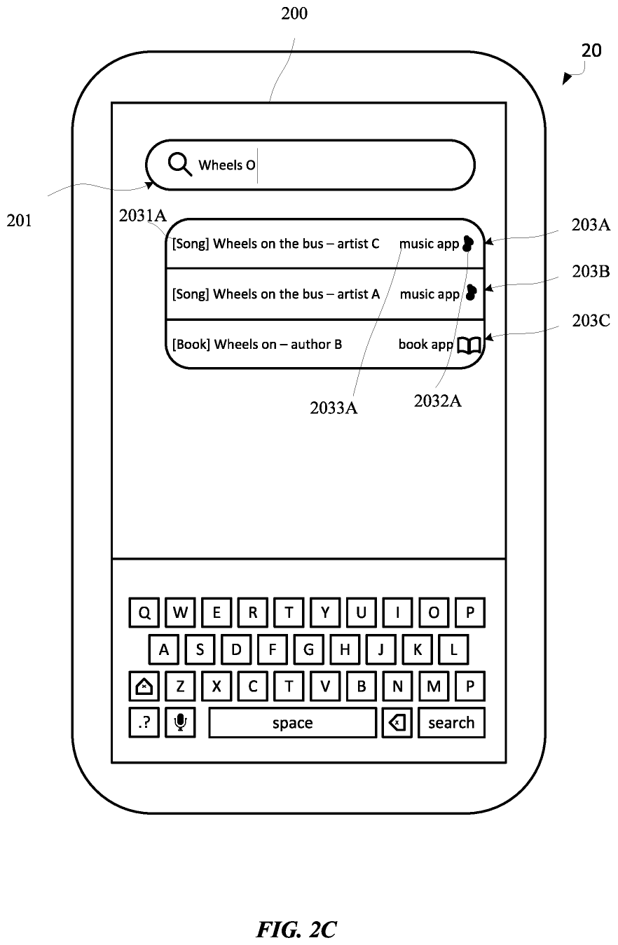

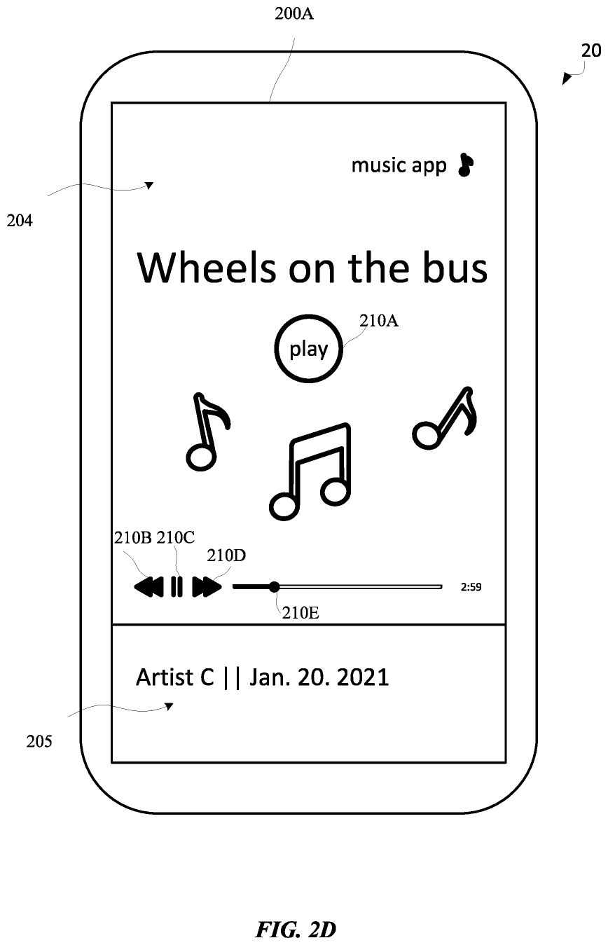

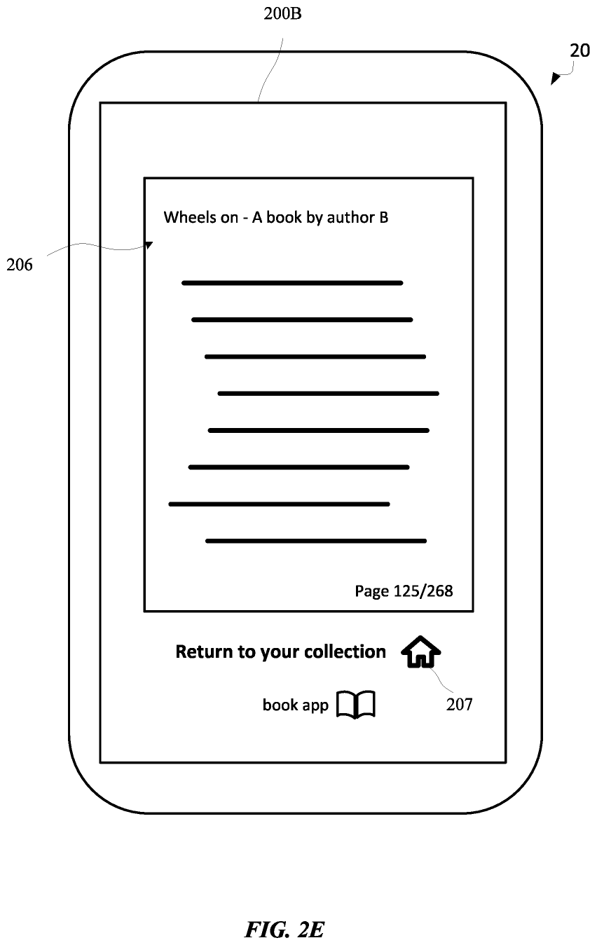

In various implementations, the unified interface generation engine 1131 can generate a unified graphical user interface (may be simply referred to as “unified interface”, see FIG. 2A or 1131A in FIG. 1B as an example) and cause the unified interface to be rendered via the client device 11 (e.g., via a display that is integrated with, or coupled to, the client device 11). In various implementations, the unified interface can include a search field to receive user input (typed, audio, etc.). A location, size, shape, and other parameters (color, etc.) of the search field can be pre-configured based on a template selected/designed by a developer, and can be subsequently modified if the template is modified. A background of the unified interface can also be pre-configured based on the template and can be subsequently modified if the template is modified.

In various implementations, the cross-app search engine 1135 can, in response to receiving user input (incomplete or complete) via the search field of the unified interface generated and rendered by the unified interface generation engine 1131, generate a cross-app search query and access the central on-device repository 1151 using the generated cross-app search query. For instance, the cross-app search engine 1135 can search the central on-device repository 1151 based on the generated cross-app search query, to identify whether there is any entry of the central on-device repository 1151 that is responsive to the generated cross-app search query.

When the cross-app search engine 1135 identifies or determined that one or more entries, of the central on-device repository 1151, are responsive to the generated cross-app search query, the cross-app search engine 1135 can generate one or more search results each corresponding to a respective entry, of the one or more identified entries from the central on-device repository 1151. Based on the one or more search results generated by the cross-app search engine 1135, the interface element generation engine 1133 can generate one or more interface elements to be displayed within the aforementioned unified interface, for user selection. In some implementations, the cross-app search system 113 includes the ranking engine 1137 to rank the identified one or more entries (or alternatively, the one or more search results). In these implementations, the interface element generation engine 1133 can selectively generate one or more interface elements based on top ranked entries or search results, for display at the unified interface.

In some implementations, the user input can be typed into the search field displayed at the unified interface. In some other implementations, the user input can be a spoken utterance (e.g., “wheels on”) received by the client device 11 when the unified interface is running in the foreground, when the unified interface is closed, or when the unified interface is running in the background. In this latter situation (i.e., when the user input is a spoken utterance), the user input can be received and processed using the automated assistant 111.

In various implementations, the automated assistant 111 can have a plurality of components including an automatic speech recognition (ASR) engine (e.g., ASR engine 111A in FIG. 1B), a text-to-speech (TTS) engine, a natural language understanding (NLU) engine, and/or a fulfillment engine. The ASR engine can process audio data that captures a spoken utterance to generate a speech recognition of the spoken utterance. The NLU engine can determine semantic meaning(s) of audio (e.g., the aforementioned audio data capturing the spoken utterance) and/or a text (e.g., natural language content from a message or the aforementioned speech recognition that is converted by the ASR engine from the audio data), and decompose the determined semantic meaning(s) to determine intent(s) and/or parameter(s) for an assistant action. For instance, the NLU engine can process natural language content of “Weather today in Louisville?”, to determine an intent (e.g., Internet search) and/or parameters (e.g., search parameters including: “weather”, “today”, and “Louisville”, or “Weather today in Louisville?”) for an assistant action (e.g., search the Internet for the weather in Louisville today).

In some implementations, the NLU engine can resolve the intent(s) and/or parameter(s) based on a single utterance of a user and, in other situations, prompts can be generated based on unresolved intent(s) and/or parameter(s). In this latter situation, the generated prompts can be rendered to the user to receive user response(s), where the user response(s) to the rendered prompt(s) can be utilized by the NLU engine in resolving intent(s) and/or parameter(s). Optionally, the NLU engine can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine can utilize one or more NLU machine learning models in determining intent(s) and/or parameter(s).

In various implementations, the fulfillment engine of the automated assistant 111 (or a fulfillment engine of the client automated assistant application, which is not illustrated) can receive an intent and/or parameter(s) of the intent, to fulfill the intent by performing a corresponding assistant action. As a non-limiting example, the fulfillment engine can receive the aforementioned intent of Internet search and the aforementioned search parameter of “Weather today in Louisville?”, to cause a search engine of the client device 11 to search the Internet for “Weather today in Louisville?”. In this example, the fulfillment engine can fulfill the intent by: (1) causing the search engine to search the Internet for the user query, i.e., “Weather today in Louisville?”), (2) generating fulfillment information (e.g., “it's cloudy outside, with a temperature of 26-C”), based on a search result (e.g., “Louisville, KY, Monday 11:00 am, cloudy, 26° C.”) of the search, and/or (3) rendering the fulfillment information to the user of the client device 11. As another non-limiting example, the fulfillment engine can receive an intent and/or parameter(s) for an assistant action that causes a thermostat in the living room to set room temperature at 72 F. In this example, the fulfillment engine can fulfill the intent by generating and forwarding a control signal to the thermostat in the living room, where the control signal causes the thermostat to set the room temperature at 72 F.

Optionally, when the NLU engine cannot resolve the intent(s) and/or cannot determine all parameter(s) for the intent(s), to fulfill an assistant action, the fulfillment engine can generate a default response, such as “Sorry, I don't understand. Please try again. In this case, the default response can be customized based on functions or a type of the automated assistant 111.

In some implementations, the TTS engine can convert a text (e.g., the aforementioned fulfillment information of “it's cloudy outside, with a temperature of 26° C.”) to a synthesized speech using a particular voice. The synthesized speech, for instance, can be generated by using one or more trained speech synthesis neural network models to process the text. The synthesized speech can be audibly rendered via hardware speaker(s) of the client device 11 (e.g., a stand-alone speaker) or via another device (e.g., a cell phone). In some implementations, the automated assistant 111 can be in communication with a cloud-based automated assistant via one or more networks. The cloud-based automated assistant can have a plurality of cloud-based components, the same as or similar to the plurality of components of the automated assistant 111, while possessing stronger processing capabilities.

FIG. 1B depicts a flow chart showing cross-app search results generated based on partial user input, in accordance with various implementations. As shown in FIG. 1B, a user can provide a partial spoken utterance (or a complete spoken utterance, or other types of user input) of “Wheels on” to the client device 11. The user can provide such spoken utterance when a unified interface 1131A is displayed at the client device 11, or can provide such spoken utterance when the unified interface 1131A is not displayed. The ASR engine 111A of the client device 11 (or of the automated assistant 111 in FIG. 1A) can process the partial spoken utterance of “Wheels on” to generate a speech recognition 104 (in this case, [wheels on]) in natural language and forward the generated speech recognition 104 to the search engine 1135.

Based on the speech recognition 104 (e.g., [wheels on]), the search engine 1135 can generate a cross-app search query (e.g., “search ‘wheels on’ in the central on-device repository”), and access the central on-device repository 1151 based on the cross-app search query. For instance, the search engine 1135 can search the central on-device repository 1151 to determine whether the central on-device repository 1151 includes one or more data entries (“entries”) responsive to the speech recognition 104 (e.g., [wheels on]). When the search engine 1135 determines that the central on-device repository 1151 includes one or more data entries (“entries”) responsive to the speech recognition 104 (e.g., [wheels on]), the search engine 1135 can generate one or more search results 106 (e.g., in natural language) that respectively correspond to the determined one or more data entries. When the search engine 1135 determines that the central on-device repository 1151 includes no data entry responsive to the speech recognition 104 (e.g., [wheels on]), the search engine 1135 can generate a default search result (e.g., “no result found” or any other applicable text).

In various implementations, the one or more search results 106 generated by the search engine 1135 can be forwarded to the interface element generation engine 1133. In these implementations, the interface element generation engine 1133 can process the one or more search results 106, to generate one or more interface elements 107A˜107N based on the one or more search results 106. The interface element generation engine 1133 can further cause the one or more search results 106 to be displayed at the unified interface 1131A in response to receiving the spoken utterance 102.

Optionally, the interface element generation engine 1133 can include, or otherwise in communication with, a ranking engine (e.g., the ranking engine 1137 in FIG. 1A). In this case, the one or more search results 106 generated by the search engine 1135 can be forwarded to the ranking engine to be ranked, and the interface element generation engine 1133 can select a subset of search results (e.g., the highest ranked search results or the top 3 ranked search results), from the one or more search results 106. For each search result in the subset of search results that are selected from the one or more search results 106, the interface element generation engine 1133 can respectively generate and render a corresponding interface element at the unified interface 1131A. It's noted that the client device 11 can communicate with a server 15 via one or more networks 13.

FIG. 2A depicts an example of a unified interface having a search field, in accordance with various implementations. FIG. 2B depicts the user interface in FIG. 2A receiving partial user input, in accordance with various implementations. FIG. 2C depicts the user interface displaying one or more cross-app search results determined based on the partial user input in FIG. 2B, in accordance with various implementations. FIG. 2D depicts an example user interface of a music application being displayed in response to user selection of a corresponding cross-app search result, of the one or more cross-app search results in FIG. 2C, in accordance with various implementations. FIG. 2E depicts another example user interface of a book application being displayed in response to user selection of a corresponding cross-app search result, of the one or more cross-app search results in FIG. 2C, in accordance with various implementations.

As shown in FIG. 2A, a unified interface 200 can be displayed at a display of a client device 20. The unified interface 200 can include a search field 201 to receive user input (e.g., typed, audio, etc.). For instance, a user of the client device 20 can touch or click any area within the search field 201 to trigger the display of a virtual keyboard (e.g., virtual keyboard 202 in FIG. 2B), so that the user can provide typed user input in natural language. As another instance, the search field 201 can include an icon 201A which, when selected by the user (e.g., by click or touch), activates a microphone of the client device 11 to await spoken utterance(s) from the user as user input. Other than or instead of the search field 201, the unified interface 200 can include other components/elements, which can include but are not limited to, a graphical user interface element showing content/information that was previously accessed by the user using a particular application and that was most recently donated by the particular application to the aforementioned central on-device repository.

Referring to FIG. 2B, the user can type in a partial user input 201B (e.g., “Wheels O” using a virtual keyboard 202. For instance, the user can touch or click any area within the search field 201. In response, the virtual keyboard 202 can be popped up for the user to type in textual content (e.g., the partial user input 201B such as “Wheels O”). In this case, a cross-app search query (e.g., “search the central on-device repository for ‘Wheels O’”) can be generated based on the partial user input 201B to search the aforementioned central on-device repository. Such cross-app search query can be generated in response to the user selecting a “search” button (or any other applicable button) of the virtual keyboard 202. Alternatively, the cross-app search query can be generated automatically, without receiving any user confirmation or selection.

After searching the central on-device repository using the cross-app search query, one or more entries of the central on-device repository may be determined to be responsive to the cross-app search query. For instance, three entries of the central on-device repository can be determined to be responsive to the cross-app search query (e.g., “search the central on-device repository for ‘Wheels O’”), where the three entries can include a first entry identifying a source application (e.g., music app) that donates information/content to create the first entry in the central on-device repository, a type of the donated content (e.g., song), and an identifier of the donated content (e.g., “Wheels on the bus by artist C”.

The three responsive entries can further include a second entry identifying a source application (e.g., music app) that donates information/content to create the second entry in the central on-device repository, a type of the donated content (e.g., song), and an identifier of the donated content (e.g., “Wheels on the bus by artist A”. The three responsive entries can further include a third entry identifying a source application (e.g., book app) that donates information/content to create the third entry in the central on-device repository, a type of the donated content (e.g., book), and an identifier of the donated content (e.g., “Wheels on by author B”). Optionally, the first entry can include additional data, such as the time the donated content was accessed by the user using the first application, the time the donated content was donated to the central on-device repository by the first application, a link to launch the first application in a particular state (e.g., a particular interface for playing the song “Wheels on the bus” performed by artist C).

Referring to FIG. 2C, based on the three responsive entries, three interface elements 203A, 203B, and 203C can be generated and rendered at the unified interface 200. For instance, the three interface elements 203A, 203B, and 203C can be displayed below the search field 201. Alternatively, in response to the user typing in “Wheels O”, the three interface elements 203A, 203B, and 203C can be displayed within a dropdown menu, of the search field 201, that is automatically displayed without user clicking on the “search” key (or “enter” key or other applicable key) of the virtual keyboard 202. Each of the three interface elements 203A, 203B, and 203C can include information/content such as a name and/or type of donated content (e.g., 2031A) determined from the central on-device repository as being responsive to the user input, a logo (e.g., 2032A) for a corresponding source application, a name (e.g., 2033A) of the corresponding source application.

Each of the three interface elements 203A, 203B, and 203C can be selected by the user. For example, the user can select, among the aforementioned three interface elements (203A˜203C), a first interface element 203A. Referring to FIG. 2D, in response to the user selecting the first interface elements 203A, a particular graphical user interface 200A of the music app that corresponds to a particular state of the music app can be displayed at the client device 20 to replace the unified interface 200. The graphical user interface 200A of the music app can, for instance, include a video-playing region 204 to play a video of the song “Wheels on the bus”. The video-playing region 204, for instance, can include a plurality of selectable elements (e.g., a “play” button 210A, a “backwards” button 210B, a “pause” button 210C, a “forward” button 210D, and/or a slider 210E to select the starting point of the play. Optionally, the graphical user interface 200A of the music app can include an introduction section 205 of the song “Wheels on the bus”, including a name of the artist (e.g., artist C) that performs the song, a date of the song being performed, and/or other information.

As another example, the user can select, among the aforementioned three interface elements (203A˜203C), a second interface element 203B. Referring to FIG. 2E, in response to the user selecting the second interface element 203B, a particular graphical user interface 200B of the book app can be displayed at the client device 20. The particular graphical user interface 200B of the book app can include a reading region 206 to display a particular page (e.g., page 125 out of a total number of pages 268, the last page the user accessed or read when using the book app to read “Wheels on”) of the book “Wheels on”, for the user to consume his or her reading. The particular graphical user interface 200B can, for instance, further other elements, such as a “house” button 207 to return to a menu or collection of books the user downloaded or saved in the book app.

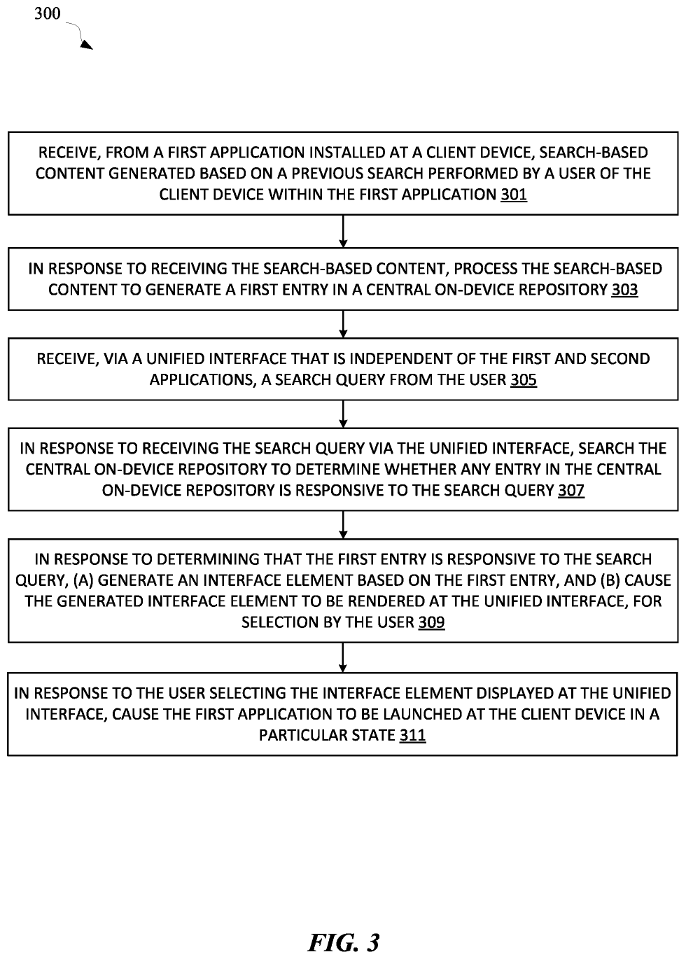

FIG. 3 illustrates a flowchart illustrating an example method 300 for generating one or more suggestions for display within an overlay of a particular application based on suggestion-generation criteria specific to the particular application, in accordance with various implementations. For convenience, the operations of the method 300 are described with reference to a system that performs the operations. The system of method 300 includes one or more processors and/or other component(s) of a client device and/or of a server device. Moreover, while operations of the method 300 are shown in a particular order, this is not meant to be limiting. One or more operations may be reordered, omitted, or added.

Referring to FIG. 3, in various implementations, at block 301, the system can receive, from a first application installed at a client device, search-based content generated based on a previous search performed by a user of the client device within the first application.

In various implementations, at block 303, the system can, in response to receiving the search-based content, process the search-based content to generate a first entry in a central on-device repository. The central on-device repository can be locally stored at the client device and can include a second entry generated based on content received from a second application that is different from the first application.

In various implementations, at block 305, the system can receive, via a unified interface that is independent of the first and second applications, a search query from the user.

In various implementations, at block 307, the system can, in response to receiving the search query via the unified interface, search the central on-device repository to determine whether any entry in the central on-device repository is responsive to the search query.

In various implementations, at block 309, the system can, in response to determining that the first entry is responsive to the search query, (a) generate an interface element based on the first entry, and (b) cause the generated interface element to be rendered at the unified interface, for selection by the user.

In various implementations, at block 311, the system can, in response to the user selecting the interface element displayed at the unified interface, cause the first application to be launched at the client device in a particular state.

In some implementations, the first entry includes in-app content that is accessible via the first application and that is responsive to the previous search. In these implementations, the system can cause the first application to be launched at the client device in a particular state by: causing a particular user interface of the first application to be rendered at the client device, wherein the particular user interface displays the in-app content that is accessible via the first application and that is responsive to the previous search.

In some implementations, optionally, the search-based content or the first entry includes a content identifier of the in-app content.

In some implementations, optionally, the search-based content or the first entry includes user input from the user to perform the previous search within the first application. The user input can be incomplete or complete.

In some implementations, optionally, the search-based content or the first entry includes in-app search query suggestion generated by a source application (e.g., the aforementioned music app) that donates the search-based content to the central on-device repository, based on incomplete user query user input from the user.

In some implementations, receiving the search-based content donated by the first application is in response to the user input being received via the first application. In other words, the first application can donate the search-based content to the central on-device repository in response to the user input/query (be it complete or incomplete) being received via the first application.

Alternatively, in some implementations, receiving the search-based content donated by the first application is in response to user selection of a search result that is generated based on the user input or user query. For instance, the first application can donate the search-based content to the central on-device repository in response to the user selecting a search result, from one or more search results that are generated based on the user input/query received by the first application.

Alternatively, in some implementations, receiving the search-based content donated by the first application is in response to the user accessing in-app content of the first application that is responsive to the user input or user query received by the first application for a predetermined amount of time. For instance, the first application can donate the search-based content to the central on-device repository in response to the user accessing the in-app content of the first application for the predetermined amount of time. Optionally, the in-app content, an identifier of the in-app content, and/or a link or shortcut to the in-app content can be included in the search-based content that is donated to the central on-device repository.

In some implementations, optionally, the search-based content or the first entry includes an application identifier of the first application.

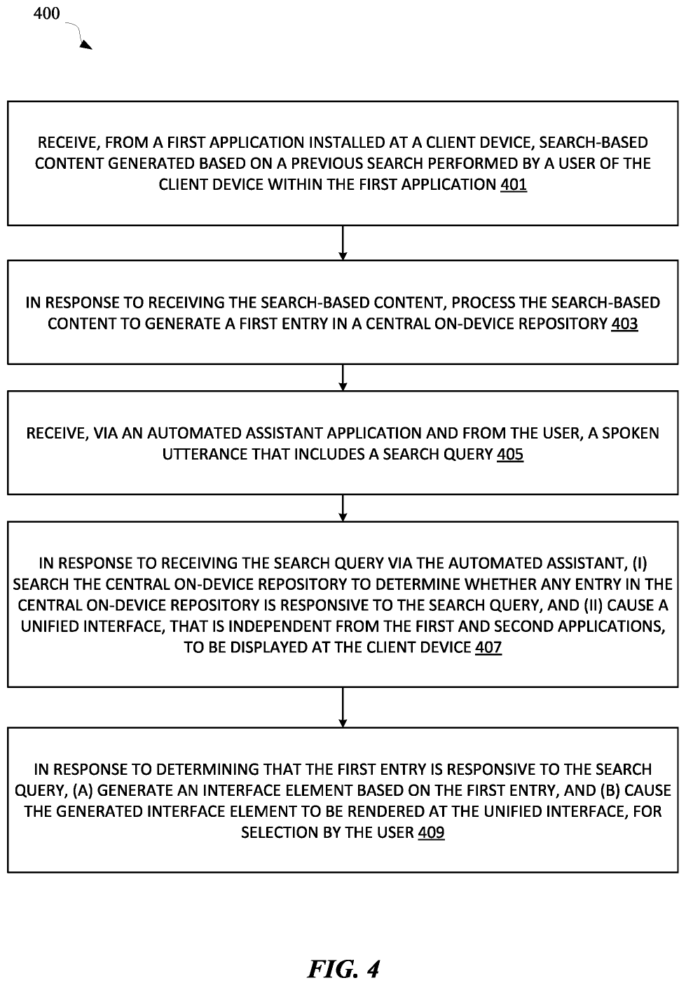

FIG. 4 illustrates a flowchart illustrating an example method 400 for generating one or more suggestions for display within an overlay of a particular application based on suggestion-generation criteria specific to the particular application, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

Referring to FIG. 4, in various implementations, at block 401, the system can receive, from a first application installed at a client device, search-based content generated based on a previous search performed by a user of the client device within the first application.

In various implementations, at block 403, the system can, in response to receiving the search-based content, process the search-based content to generate a first entry in a central on-device repository. The central on-device repository can be locally stored at the client device and can include a second entry generated based on content received from a second application that is different from the first application.

In various implementations, at block 405, the system can receive, via an automated assistant application and from the user, a spoken utterance that includes a search query. For instance, the automated assistant application can include an ASR engine that processes the spoken utterance to recognize the search query, i.e., to determine a natural language recognition of the search query.

In various implementations, at block 407, the system can, in response to receiving the search query via the automated assistant, (i) search the central on-device repository to determine whether any entry in the central on-device repository is responsive to the search query, and (ii) cause a unified interface, that is independent from the first and second applications, to be displayed at the client device.

In various implementations, at block 409, the system can, in response to determining that the first entry is responsive to the search query, (a) generate an interface element based on the first entry, and (b) cause the generated interface element to be rendered at the unified interface, for selection by the user.

In some implementations, the first entry includes in-app content that is accessible via the first application and that is responsive to the previous search. In these implementations, the system can cause the first application to be launched at the client device in a particular state by: causing a particular user interface of the first application to be rendered at the client device, wherein the particular user interface displays the in-app content that is accessible via the first application and that is responsive to the previous search.

In some implementations, optionally, the search-based content or the first entry includes a content identifier of the in-app content.

In some implementations, optionally, the search-based content or the first entry includes user input from the user to perform the previous search within the first application. The user input can be incomplete or complete.

In some implementations, optionally, the search-based content or the first entry includes in-app search query suggestion generated by a source application (e.g., the aforementioned music app) that donates the search-based content to the central on-device repository, based on incomplete user query user input from the user.

In some implementations, receiving the search-based content donated by the first application is in response to the user input being received via the first application. In other words, the first application can donate the search-based content to the central on-device repository in response to the user input/query (be it complete or incomplete) being received via the first application.

Alternatively, in some implementations, receiving the search-based content donated by the first application is in response to user selection of a search result that is generated based on the user input or user query. For instance, the first application can donate the search-based content to the central on-device repository in response to the user selecting a search result, from one or more search results that are generated based on the user input/query received by the first application.

Alternatively, in some implementations, receiving the search-based content donated by the first application is in response to the user accessing in-app content of the first application that is responsive to the user input or user query received by the first application for a predetermined amount of time. For instance, the first application can donate the search-based content to the central on-device repository in response to the user accessing the in-app content of the first application for the predetermined amount of time. Optionally, the in-app content, an identifier of the in-app content, and/or a link or shortcut to the in-app content can be included in the search-based content that is donated to the central on-device repository.

In some implementations, optionally, the search-based content or the first entry includes an application identifier of the first application.

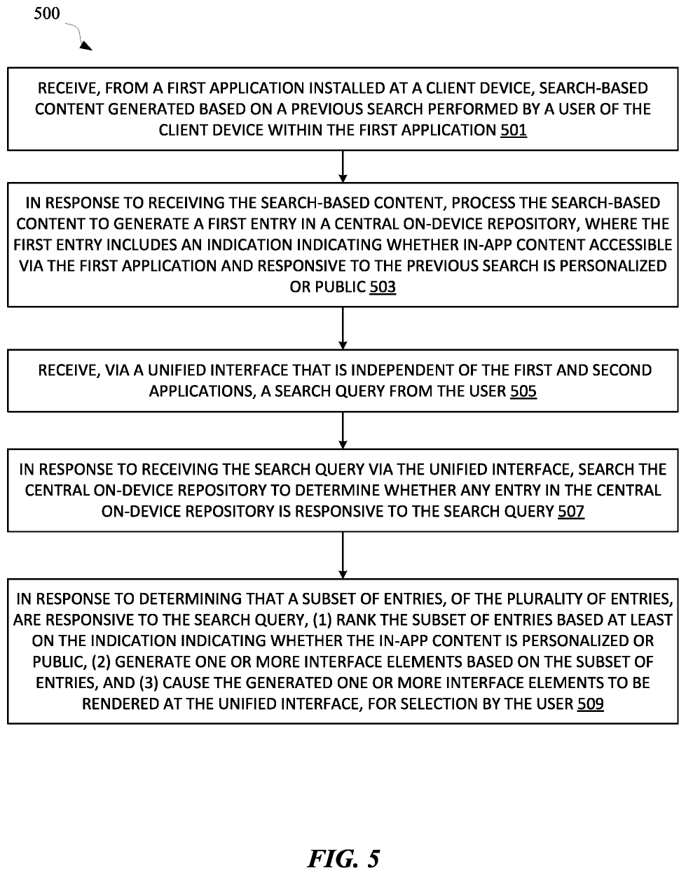

FIG. 5 is a flowchart illustrating an additional example method 500 for generating one or more suggestions, in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

In various implementations, at block 501, the system can receive, from a first application installed at a client device, search-based content generated based on a previous search performed by a user of the client device within the first application.

In various implementations, at block 503, the system can, in response to receiving the search-based content, process the search-based content to generate a first entry in a central on-device repository. The central on-device repository can be locally stored at the client device and can include a plurality of entries generated based on content received from different applications that include the first application.

The first entry can include an indication indicating whether in-app content accessible via the first application and responsive to the previous search is personalized or public.

In various implementations, at block 505, the system can receive, via a unified interface that is independent of the first and second applications, a search query from the user.

In various implementations, at block 507, the system can, in response to receiving the search query via the unified interface, search the central on-device repository to determine whether any entry in the central on-device repository is responsive to the search query.

In various implementations, at block 509, the system can, in response to determining that a subset of entries, of the plurality of entries, are responsive to the search query, (1) rank the subset of entries based at least on the indication indicating whether the in-app content is personalized or public, (2) generate one or more interface elements based on the subset of entries, and (3) cause the generated one or more interface elements to be rendered at the unified interface, for selection by the user.

In various implementations, the system can cause the first application to be launched at the client device in a particular state, in response to the user selecting a particular interface element, of the one or more interface elements, that is generated based on the first entry and that is displayed at the unified interface.

In various implementations, the system can cause the first application to be launched at the client device in a particular state by: causing a particular user interface of the first application to be rendered at the client device, wherein the particular user interface displays the in-app content that is accessible via the first application and that is responsive to the previous search.

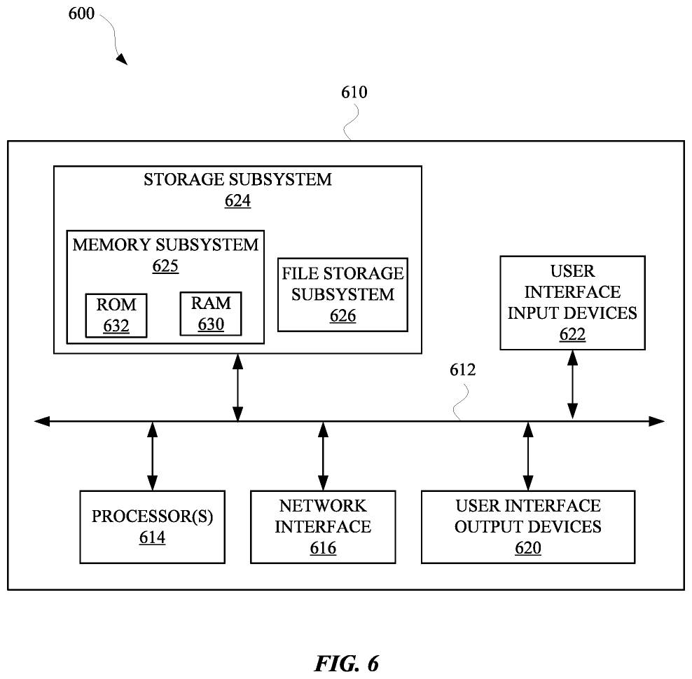

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A computer-implemented method, comprising:
receiving, from a first application installed at a client device, search-based content generated based on a previous search performed by a user of the client device within the first application;
in response to receiving the search-based content, processing the search-based content to generate a first entry in a central on-device repository, the central on-device repository being locally stored at the client device and including a second entry generated based on content received from a second application that is different from the first application;
receiving, via a unified interface that is independent of the first and second applications, a search query from the user;
in response to receiving the search query via the unified interface, searching the central on-device repository to determine whether any entry in the central on-device repository is responsive to the search query; and
in response to determining that the first entry is responsive to the search query,
generating an interface element based on the first entry, and
causing the generated interface element to be rendered at the unified interface, for selection by the user.

2. The method of claim 1, further comprising:
in response to the user selecting the interface element displayed at the unified interface, causing the first application to be launched at the client device in a particular state.

3. The method of claim 2, wherein the first entry includes in-app content that is accessible via the first application and that is responsive to the previous search, and wherein causing the first application to be launched at the client device in a particular state comprises:
causing a particular user interface of the first application to be rendered at the client device, wherein the particular user interface displays the in-app content that is accessible via the first application and that is responsive to the previous search.

4. The method of claim 3, wherein the search-based content includes a content identifier of the in-app content.

5. The method of claim 1, wherein the first entry includes user input from the user to perform the previous search within the first application.

6. The method of claim 5, wherein receiving the search-based content is in response to the user input being received via the first application.

7. The method of claim 1, wherein the previous search performed within the first application leads to a search result that is selected by the user and that describes the in-app content, and wherein receiving the search-based content is in response to the user selecting the search result.

8. The method of claim 1, wherein the first entry includes an application identifier of the first application.

9. A computer-implemented method, comprising:
receiving, from a first application installed at a client device, search-based content generated based on a previous search performed by a user of the client device within the first application;
in response to receiving the search-based content, processing the search-based content to generate a first entry in a central on-device repository, the central on-device repository being locally stored at the client device and including a second entry generated based on content received from a second application that is different from the first application;
receiving, via an automated assistant application and from the user, a spoken utterance that includes a search query;
in response to receiving the search query via the automated assistant,
searching the central on-device repository to determine whether any entry in the central on-device repository is responsive to the search query, and
causing a unified interface, that is independent from the first and second applications, to be displayed at the client device; and
in response to determining that the first entry is responsive to the search query,
generating an interface element based on the first entry, and
causing the generated interface element to be rendered at the unified interface, for selection by the user.

10. The method of claim 9, further comprising:
in response to the user selecting the interface element displayed at the unified interface, causing the first application to be launched at the client device in a particular state.

11. The method of claim 10, wherein the first entry includes in-app content that is accessible via the first application and that is responsive to the previous search, and wherein causing the first application to be launched at the client device in a particular state comprises:
causing a particular user interface of the first application to be rendered at the client device, wherein the particular user interface displays the in-app content that is accessible via the first application and that is responsive to the previous search.

12. The method of claim 11, wherein the search-based content includes a content identifier of the in-app content.

13. The method of claim 11, wherein the first entry includes an indication indicating whether the in-app content is personalized or public.

14. The method of claim 9, wherein the first entry includes user input from the user to perform the previous search within the first application.

15. The method of claim 14, wherein receiving the search-based content is in response to the user input being received via the first application.

16. The method of claim 9, wherein the previous search performed within the first application leads to a search result that is selected by the user and that describes the in-app content, and wherein receiving the search-based content is in response to the user selecting the search result.

17. A computer-implemented method, comprising:
receiving, from a first application installed at a client device, search-based content generated based on a previous search performed by a user of the client device within the first application;
in response to receiving the search-based content, processing the search-based content to generate a first entry in a central on-device repository,
wherein the central on-device repository is locally stored at the client device and includes a plurality of entries generated based on content received from different applications that include the first application, and
wherein the first entry includes an indication indicating whether in-app content accessible via the first application and responsive to the previous search is personalized or public;
receiving, via a unified interface that is independent of the first and second applications, a search query from the user;
in response to receiving the search query via the unified interface, searching the central on-device repository to determine whether any entry in the central on-device repository is responsive to the search query; and
in response to determining that a subset of entries, of the plurality of entries, that include the first entry, are responsive to the search query,
ranking the subset of entries based at least on the indication indicating whether the in-app content is personalized or public,
generating one or more interface elements based on the subset of entries, and
causing the generated one or more interface elements to be rendered at the unified interface, for selection by the user.

18. The method of claim 17, further comprising:
in response to the user selecting a particular interface element, of the one or more interface elements, that is generated based on the first entry and that is displayed at the unified interface, causing the first application to be launched at the client device in a particular state.

19. The method of claim 18, wherein causing the first application to be launched at the client device in a particular state comprises:
causing a particular user interface of the first application to be rendered at the client device, wherein the particular user interface displays the in-app content that is accessible via the first application and that is responsive to the previous search.

20. The method of claim 17, wherein the first entry includes user input from the user to perform the previous search within the first application.
